(19) United States
(12) Patent Application Publication
(10) Pub. No.: US 2017/0111512 A1
(43) Pub. Date: Apr. 20, 2017

(54) METHODS FOR PLACING A VIDEO TELEPHONY CALL FOR NON-IMS 4G SUBSCRIPTIONS

(71) Applicant: QUALCOMM Incorporated, San Diego, CA (US)

(72) Inventors: Harish REDDY KOTHAKAPU, Hyderabad (IN); Bhanu Kiran JANGA, Hyderabad (IN); Ajit GUPTA, Hyderabad (IN); Venkatesh Savithri MAHESH, Hyderabad (IN); Guatam Kumar GUPTA, Hyderabad (IN); Raju KASARAMONI, Hyderabad (IN)

(21) Appl. No.: 15/270,624

(22) Filed: Sep. 20, 2016

(30) Foreign Application Priority Data
Oct. 20, 2015 (IN) 3968/MUM/2015

(51) Int. Cl. H04M 7/00; H04W 76/02; H04L 29/06

(52) U.S. Cl. CPC H04M 7/006; H04L 65/403; H04L 65/1016; H04W 76/026

(57) ABSTRACT

Aspects of the present disclosure provide an apparatus and techniques for wireless communication by a user equipment (UE), such as placing a video telephony (VT) call when a user equipment (UE) is camped on a non-Internet Protocol Multimedia Subsystem (IMS) network, such as a non-IMS Long Term Evolution (LTE) network. The UE may be in a coverage area of a first radio access technology (RAT) supported by a first standard, and in a coverage area of a second RAT supported by a second standard. The UE may determine the LTE network does not support IMS services. In response to the determination, the UE may take one or more actions to place a VT call using the second RAT which supports IMS services.

### CROSS REFERENCE TO RELATED APPLICATIONS

This application claims benefit of Indian Provisional Patent Application Number 3968/MUM/2015, entitled “Methods for Placing a Video Telephony Call for Non-IMS 4G Subscriptions,” filed on 20 Oct. 2015, which is expressly incorporated by reference herein in its entirety.

### FIELD

Aspects of the present disclosure generally relate to wireless communication by a user equipment (UE), such as a UE connected to a 4G subscription which does not support Internet Protocol Multimedia Subsystem (IMS) services and, more particularly, for placing a video telephony (VT) call (e.g., such as a circuit switched VT (CS VT call) by a UE connected to a subscription which does not support VT calls.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency divisional multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example of an emerging telecommunication standard is Long Term Evolution (LTE). LTE/LTE-Advanced is a set of enhancements to the Universal Mobile Telecommunications System (UMTS) mobile standard promulgated by Third Generation Partnership Project (3GPP). It is designed to better support mobile broadband Internet access by improving spectral efficiency, lower costs, improve services, make use of new spectrum, and better integrate with other open standards using OFDMA on the downlink (DL), SC-FDMA on the uplink (UL), and multiple-input multiple-output (MIMO) antenna technology. However, as the demand for mobile broadband access continues to increase, there exists a need for further improvements in LTE technology. Preferably, these improvements should be applicable to other multi-access technologies and the telecommunication standards that employ these technologies.

A UE may be located within the coverage area of multiple wireless networks and/or subscription, which may be supported by different standards. A UE may be in the coverage area of, for example, a 2G network, a 3G network, 4G (e.g., LTE, LTE-A) network, and/or a 5G network. Each of these networks may be supported by different standards. To facilitate a seamless user experience, techniques may be desired for a UE to access different networks based on a desired service.

### SUMMARY

Certain aspects of the present disclosure provide a method for wireless communication by a user equipment (UE) camped on a Long Term Evolution (LTE) network, in a coverage area of a first radio access technology (RAT) supported by a first standard, and in a coverage area of a second RAT supported by a second standard. The UE may determine the LTE network does not support Internet Protocol Multimedia Subsystem (IMS) services, and in response to the determination, the UE may take one or more actions to place a video telephony call using the second RAT.

The UE may search for the second RAT upon receiving a video telephony call request, establish a communication session using the second RAT, and place the video telephony call using the second RAT. The UE may discontinue the communication session with the second RAT upon termination of the video telephony call.

The UE may perform an Extended Service Request (ESR) procedure with the LTE network, redirect to the first RAT as a result of the ESR procedure, take one or more actions to move from the LTE network to the second RAT, and place the video telephony call using the second RAT. According to aspects, the one or more actions to move from the LTE network to the second RAT may include at least one of performing a redirection to the second RAT or scanning for available networks associated with the second RAT. The UE may discontinue a communication session with the second RAT upon termination of the video telephony call.

According to aspects, in response to determining the LTE network does not support IMS services, the UE may perform an ESR procedure with the LTE network upon receiving a video telephony call request, and avoid transfer to the first RAT as a result of the ESR procedure.

According to aspects, the first RAT may not support video telephony services.

According to aspects, at least one of the first RAT is a 2G RAT or the second RAT is a 3G RAT. According to one example, the first RAT may be a 2G RAT and the second RAT may be a 3G RAT.

Certain aspects of the present disclosure provide an apparatus for wireless communication by a user equipment (UE) camped on a Long Term Evolution (LTE) network, in a coverage area of a first radio access technology (RAT) supported by a first standard, and in a coverage area of a second RAT supported by a second standard. The apparatus generally includes means for determining the LTE network does not support Internet Protocol Multimedia Subsystem (IMS) services, and in response to the determination, means for taking one or more actions to place a video telephony call using the second RAT.

Certain aspects of the present disclosure provide an apparatus for wireless communication by a user equipment (UE) camped on a Long Term Evolution (LTE) network, in a coverage area of a first radio access technology (RAT) supported by a first standard, and in a coverage area of a second RAT supported by a second standard. The apparatus generally includes at least one processor and a memory coupled with the at least one processor. The at least one processor is generally configured to determine the LTE network does not support Internet Protocol Multimedia Subsystem (IMS) services, and in response to the determination, take one or more actions to place a video telephony call using the second RAT.

Certain aspects of the present disclosure provide a computer readable medium storing computer executable code for causing a user equipment (UE) camped on a Long Term Evolution (LTE) network, in a coverage area of a first radio access technology (RAT) supported by a first standard, and in a coverage area of a second RAT supported by a second standard to determine the LTE network does not support Internet Protocol Multimedia Subsystem (IMS) services, and in response to the determination, take one or more actions to place a video telephony call using the second RAT.

Aspects generally include methods, apparatus, systems, computer program products, and processing systems, as substantially described herein with reference to and as illustrated by the accompanying drawings.

### BRIEF DESCRIPTION OF THE DRAWINGS

FIG. 1 is a diagram illustrating an example of architecture of multiple wireless communication access networks, in accordance with certain aspects of the disclosure.

FIG. 2 is a diagram illustrating an example of an access network, in accordance with certain aspects of the disclosure

FIG. 3 is a diagram illustrating an example of a DL frame structure in LTE, in accordance with certain aspects of the disclosure.

FIG. 4 is a diagram illustrating an example of an UL frame structure in LTE, in accordance with certain aspects of the disclosure.

FIG. 5 is a diagram illustrating an example of a radio protocol architecture for the user and control plane, in accordance with certain aspects of the disclosure.

FIG. 6 is a diagram illustrating an example of an evolved Node B (eNB) and user equipment (UE) in an access network, in accordance with certain aspects of the disclosure.

FIG. 7 illustrates example an example call-flow diagram, in accordance with certain aspects of the disclosure.

FIG. 8 illustrates example operations performed by a UE, in accordance with certain aspects of the disclosure.

FIG. 9 illustrates an example call-flow diagram for a UE searching for an IMS-supported subscription prior to placing a VT call, in accordance with certain aspects of the disclosure.

FIG. 10 illustrates and example call-flow diagram for a UE avoiding transferring to a subscription which does not support VT calls, in accordance with certain aspects of the disclosure.

### DETAILED DESCRIPTION

Aspects of the present disclosure provide apparatus, methods, processing systems, and computer program products processing a CS VT call when a UE is camped on a network that does not support Internet Protocol Multimedia Subsystem (IMS) services. As will be described in more detail herein, certain 4G (e.g., LTE) deployments (e.g., subscriptions) may not support IMS services, and consequently, may not support VT calls. Aspects of the present disclosure provide techniques for a UE camped on such a network that does not support IMS services to place a VT (e.g., CS VT) call using a subscription that supports IMS services (e.g., a subscription that supports a CS VT call).

More specifically, the UE may be camped on an LTE network and the UE may also be in the coverage area of a first radio access technology (RAT) supported by a first standard, and in a coverage area of a second RAT supported by a second standard. The first RAT may not support IMS services and the second RAT may support IMS services. According to one example, the first RAT which does not support IMS services may be a 2G RAT. Additionally or alternatively, the second RAT which supports IMS services may be a 3G RAT.

In response to determining the LTE network, on which the UE is camped, does not support IMS services (e.g., does not support a VT call), the UE may take one or more actions to place a VT call using the second RAT which supports IMS services (e.g., which supports VT calls). According to aspects, the UE may avoid being redirected to and/or camping on the first RAT that does not support IMS services (e.g., does not support VT calls) when trying to place a CS VT call. By avoiding redirection and/or not camping on a network that does not support IMS services (e.g., does not support VT calls), the UE may successfully place a CS VT call that may have otherwise failed had the UE had been directed to a network that does not support IMS services (e.g., does not support VT calls).

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well-known structures and components are shown in block diagram form in order to avoid obscuring such concepts.

Several aspects of telecommunication systems will now be presented with reference to various apparatus and methods. These apparatus and methods will be described in the following detailed description and illustrated in the accompanying drawings by various blocks, modules, components, circuits, steps, processes, algorithms, etc. (collectively referred to as “elements”). These elements may be implemented using hardware, software/firmware, or combinations thereof. Whether such elements are implemented as hardware or software depends upon the particular application and design constraints imposed on the overall system.

By way of example, an element, or any portion of an element, or any combination of elements may be implemented with a “processing system” that includes one or more processors. Examples of processors include microprocessors, microcontrollers, digital signal processors (DSPs), field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software/firmware, middleware, microcode, hardware description language, or otherwise.

Accordingly, in one or more exemplary embodiments, the functions described may be implemented in hardware, software/firmware, or combinations thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Disk and disc, as used herein, includes compact disc (CD), laser disc, optical disc, digital versatile disc (DVD), floppy disk and Blu-ray disc where disks usually reproduce data magnetically, while discs reproduce data optically with lasers. Combinations of the above should also be included within the scope of computer-readable media.

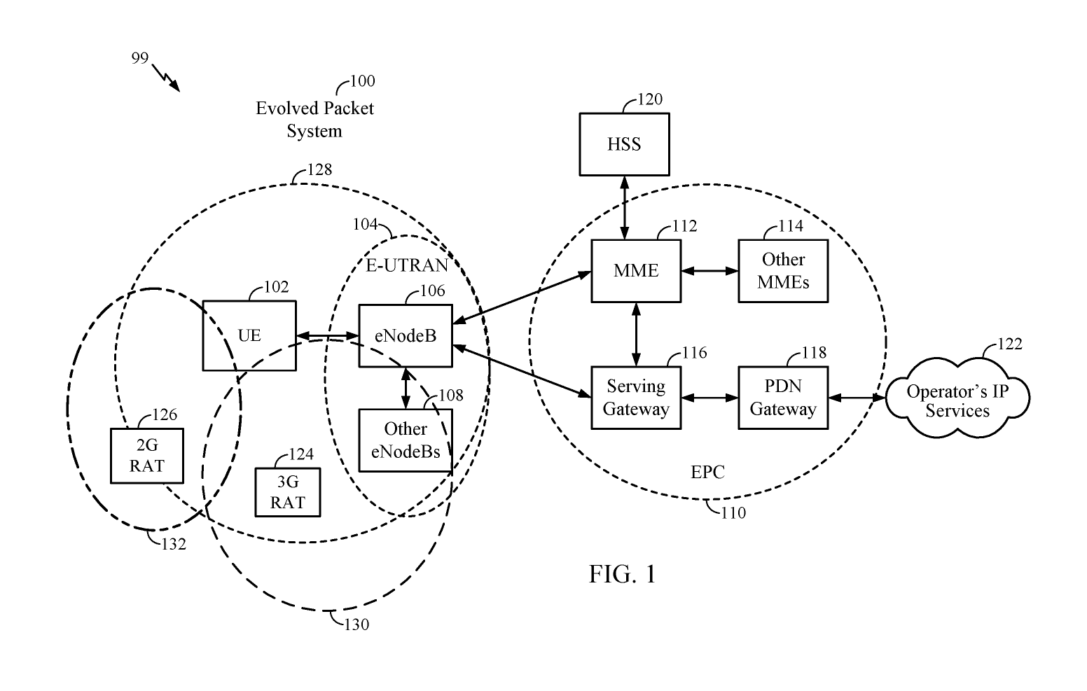

FIG. 1 is a diagram illustrating example wireless communication networks 99, in which the techniques described herein may be practiced. The UE 102 may be in the coverage area of multiple wireless communication networks. The UE 102 may be camped on an LTE network 100 (e.g., LTE subscription) and the UE 102 may also be in the coverage area of other networks, including a first RAT supported by a first standard and a second RAT supported by a second standard.

According to one example, as illustrated in FIG. 1, the UE may be camped on an LTE network 100 and may be in the coverage area of a 2G RAT 126 that does support IMS services (e.g., does not support VT calls) and in the coverage area of a 3G RAT 124 which does support IMS services (supports VT calls). Aspects of the present disclosure are described with reference to an LTE, 2G, and 3G network; however the techniques described herein may be practiced by a wireless communication device camped on any subscription that does not support IMS services (e.g., a subscription that does not support VT calls, such as LTE) and in the coverage area of at least one subscription that supports IMS services (e.g., at least one subscription that supports VT calls, such as a 3G subscription) and at least one subscription that does not support IMS services (e.g., 2G subscription). LTE, 2G, and 3G are provided for illustrative purposes. Thus, the aspects described herein are not limited to LTE, 2G, and 3G.

The LTE network and the first RAT may not support IMS services. The second RAT may support IMS services; therefore, the UE 102 may successfully place a VT call using the second RAT. As described herein, the UE may, upon determining the LTE network does not support IMS services, take one or more actions to avoid being redirected to the first RAT which does not support IMS services, and/or to search for a second RAT, which supports IMS services, to place the video telephony call. Advantageously, aspects described herein allow a UE to successfully place a CS VT call that may have otherwise failed if the UE had been directed to a network that does not support IMS services.

The LTE network architecture 100 may be referred to as an Evolved Packet System (EPS) 100. The EPS 100 may include one or more user equipment (UE) 102, an Evolved UMTS Terrestrial Radio Access Network (E-UTRAN) 104, an Evolved Packet Core (EPC) 110, a Home Subscriber Server (HSS) 120, and an Operator's IP Services 122. The EPS can interconnect with other access networks, but for simplicity those entities/interfaces are not shown. Exemplary other access networks may include an IP Multimedia Subsystem (IMS) PDN, Internet PDN, Administrative PDN (e.g., Provisioning PDN), carrier-specific PDN, operator-specific PDN, and/or GPS PDN. As shown, the EPS provides packet-switched services, however, as those skilled in the art will readily appreciate, the various concepts presented throughout this disclosure may be extended to networks providing circuit-switched services.

The E-UTRAN includes the evolved Node B (eNB) 106 and other eNBs 108. The eNB 106 provides user and control plane protocol terminations toward the UE 102. The eNB 106 may be connected to the other eNBs 108 via an X2 interface (e.g., backhaul). The eNB 106 may also be referred to as a base station, a base transceiver station, a radio base station, a radio transceiver, a transceiver function, a basic service set (BSS), an extended service set (ESS), or some other suitable terminology. The eNB 106 provides an access point to the EPC 110 for a UE 102. Examples of UEs 102 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a netbook, a smart book, or any other similar functioning device. The UE 102 may also be referred to by those skilled in the art as a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology.

The eNB 106 is connected by an 51 interface to the EPC 110. The EPC 110 includes a Mobility Management Entity (MME) 112, other MMEs 114, a Serving Gateway 116, and a Packet Data Network (PDN) Gateway 118. The MME 112 is the control node that processes the signaling between the UE 102 and the EPC 110. Generally, the MME 112 provides bearer and connection management. All user IP packets are transferred through the Serving Gateway 116, which itself is connected to the PDN Gateway 118. The PDN Gateway 118 provides UE IP address allocation as well as other functions. The PDN Gateway 118 is connected to the Operator's IP Services 122. The Operator's IP Services 122 may include, for example, the Internet, the Intranet, an IP Multimedia Subsystem (IMS), and a PS Streaming Service (PSS). In this manner, the UE 102 may be coupled to the PDN through the LTE network. Generally, a specific geographic area may be covered by one or more radio access technologies (RATs). For example, a 4G RAT such as LTE, a 3G RAT 124 such as CDMA, and a 2G RAT 126 such as a GSM are illustrated in FIG. 1. In this example, curve 128 illustrates coverage area of LTE, curve 130 illustrates coverage area of the 3G RAT 124, and curve 132 illustrates coverage area of the 2G RAT 126 network. As illustrated, different RATs may have overlapping coverage in some areas.

It is noted that while aspects may be described herein using terminology commonly associated with 3G and/or 4G wireless technologies, aspects of the present disclosure can be applied in other generation-based communication systems, such as 5G and later.

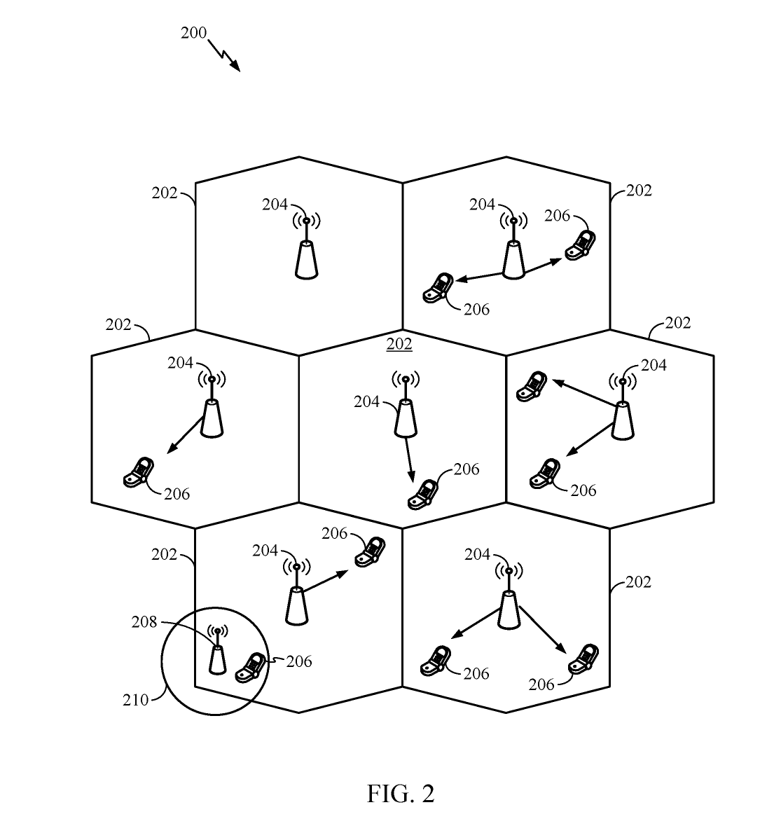

FIG. 2 is a diagram illustrating an example of an access network 200 in an LTE network architecture. In this example, the access network 200 is divided into a number of cellular regions (cells) 202. One or more lower power class eNBs 208 may have cellular regions 210 that overlap with one or more of the cells 202. A lower power class eNB 208 may be referred to as a remote radio head (RRH). The lower power class eNB 208 may be a femto cell (e.g., home eNB (HeNB)), pico cell, or micro cell. The macro eNBs 204 are each assigned to a respective cell 202 and are configured to provide an access point to the EPC 110 for all the UEs 206 in the cells 202. There is no centralized controller in this example of an access network 200, but a centralized controller may be used in alternative configurations. The eNBs 204 are responsible for all radio related functions including radio bearer control, admission control, mobility control, scheduling, security, and connectivity to the serving gateway 116.

The modulation and multiple access scheme employed by the access network 200 may vary depending on the particular telecommunications standard being deployed. In LTE applications, OFDM is used on the DL and SC-FDMA is used on the UL to support both frequency division duplexing (FDD) and time division duplexing (TDD). As those skilled in the art will readily appreciate from the detailed description to follow, the various concepts presented herein are well suited for LTE applications. However, these concepts may be readily extended to other telecommunication standards employing other modulation and multiple access techniques. By way of example, these concepts may be extended to Evolution-Data Optimized (EV-DO) or Ultra Mobile Broadband (UMB). EV-DO and UMB are air interface standards promulgated by the 3rd Generation Partnership Project 2 (3GPP2) as part of the CDMA2000 family of standards and employs CDMA to provide broadband Internet access to mobile stations. These concepts may also be extended to Universal Terrestrial Radio Access (UTRA) employing Wideband-CDMA (W-CDMA) and other variants of CDMA, such as TD-SCDMA; Global System for Mobile Communications (GSM) employing TDMA; and Evolved UTRA (E-UTRA), Ultra Mobile Broadband (UMB), IEEE 802.11 (Wi-Fi), IEEE 802.16 (WiMAX), IEEE 802.20, and Flash-OFDM employing OFDMA. UTRA, E-UTRA, UMTS, LTE and GSM are described in documents from the 3GPP organization. CDMA2000 and UMB are described in documents from the 3GPP2 organization. The actual wireless communication standard and the multiple access technology employed will depend on the specific application and the overall design constraints imposed on the system.

The eNBs 204 may have multiple antennas supporting MIMO technology. The use of MIMO technology enables the eNBs 204 to exploit the spatial domain to support spatial multiplexing, beamforming, and transmit diversity. Spatial multiplexing may be used to transmit different streams of data simultaneously on the same frequency. The data steams may be transmitted to a single UE 206 to increase the data rate or to multiple UEs 206 to increase the overall system capacity. This is achieved by spatially precoding each data stream (e.g., applying a scaling of an amplitude and a phase) and then transmitting each spatially precoded stream through multiple transmit antennas on the DL. The spatially precoded data streams arrive at the UE(s) 206 with different spatial signatures, which enables each of the UE(s) 206 to recover the one or more data streams destined for that UE 206. On the UL, each UE 206 transmits a spatially precoded data stream, which enables the eNB 204 to identify the source of each spatially precoded data stream.

Spatial multiplexing is generally used when channel conditions are good. When channel conditions are less favorable, beamforming may be used to focus the transmission energy in one or more directions. This may be achieved by spatially precoding the data for transmission through multiple antennas. To achieve good coverage at the edges of the cell, a single stream beamforming transmission may be used in combination with transmit diversity.

In the detailed description that follows, various aspects of an access network will be described with reference to a MIMO system supporting OFDM on the DL. OFDM is a spread-spectrum technique that modulates data over a number of subcarriers within an OFDM symbol. The subcarriers are spaced apart at precise frequencies. The spacing provides “orthogonality” that enables a receiver to recover the data from the subcarriers. In the time domain, a guard interval (e.g., cyclic prefix) may be added to each OFDM symbol to combat inter-OFDM-symbol interference. The UL may use SC-FDMA in the form of a DFT-spread OFDM signal to compensate for high peak-to-average power ratio (PAPR).

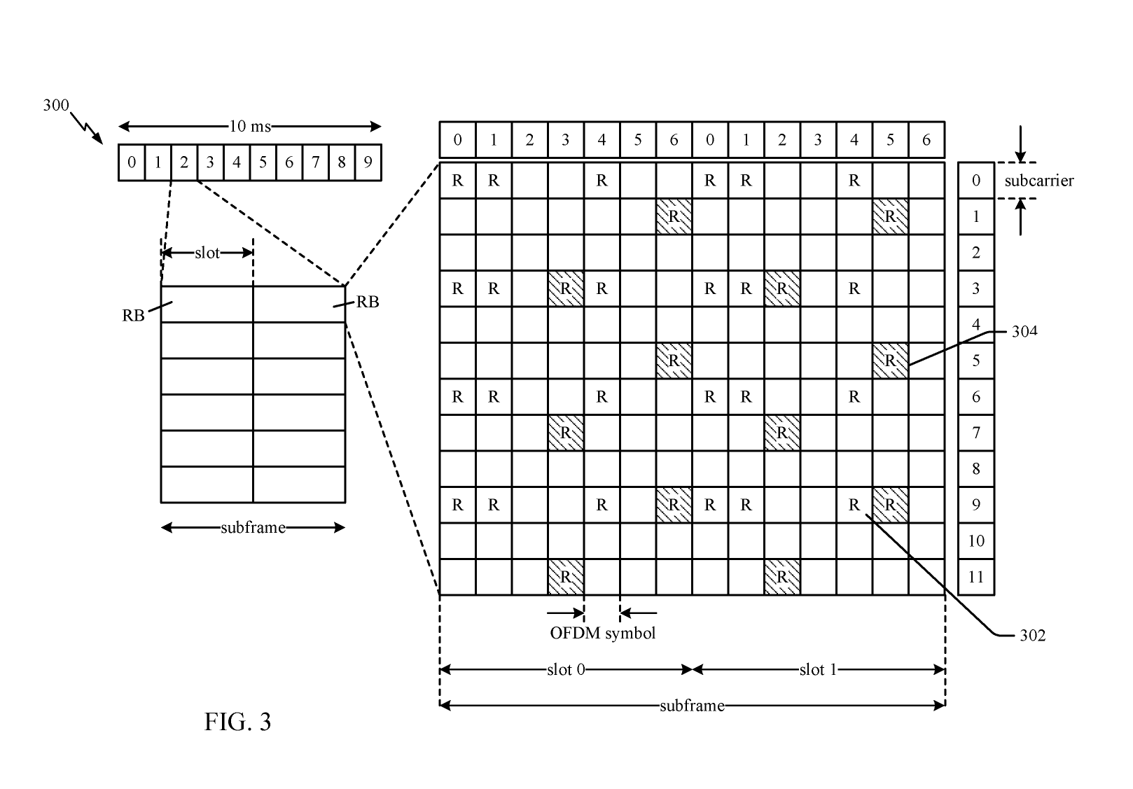

FIG. 3 is a diagram 300 illustrating an example of a DL frame structure in LTE. A frame (10 ms) may be divided into 10 equally sized sub-frames with indices of 0 through 9. Each sub-frame may include two consecutive time slots. A resource grid may be used to represent two time slots, each time slot including a resource block. The resource grid is divided into multiple resource elements. In LTE, a resource block contains 12 consecutive subcarriers in the frequency domain and, for a normal cyclic prefix in each OFDM symbol, 7 consecutive OFDM symbols in the time domain, or 84 resource elements. For an extended cyclic prefix, a resource block contains 6 consecutive OFDM symbols in the time domain and has 72 resource elements. Some of the resource elements, as indicated as R 302, 304, include DL reference signals (DL-RS). The DL-RS include Cell-specific RS (CRS) (also sometimes called common RS) 302 and UE-specific RS (UE-RS) 304. UE-RS 304 are transmitted only on the resource blocks upon which the corresponding physical DL shared channel (PDSCH) is mapped. The number of bits carried by each resource element depends on the modulation scheme. Thus, the more resource blocks that a UE receives and the higher the modulation scheme, the higher the data rate for the UE.

In LTE, an eNB may send a primary synchronization signal (PSS) and a secondary synchronization signal (SSS) for each cell in the eNB. The primary and secondary synchronization signals may be sent in symbol periods 6 and 5, respectively, in each of subframes 0 and 5 of each radio frame with the normal cyclic prefix (CP). The synchronization signals may be used by UEs for cell detection and acquisition. The eNB may send a Physical Broadcast Channel (PBCH) in symbol periods 0 to 3 in slot 1 of subframe 0. The PBCH may carry certain system information.

The eNB may send a Physical Control Format Indicator Channel (PCFICH) in the first symbol period of each subframe. The PCFICH may convey the number of symbol periods (M) used for control channels, where M may be equal to 1, 2 or 3 and may change from subframe to subframe. M may also be equal to 4 for a small system bandwidth, e.g., with less than 10 resource blocks. The eNB may send a Physical HARQ Indicator Channel (PHICH) and a Physical Downlink Control Channel (PDCCH) in the first M symbol periods of each subframe. The PHICH may carry information to support hybrid automatic repeat request (HARQ). The PDCCH may carry information on resource allocation for UEs and control information for downlink channels. The eNB may send a Physical Downlink Shared Channel (PDSCH) in the remaining symbol periods of each subframe. The PDSCH may carry data for UEs scheduled for data transmission on the downlink.

The eNB may send the PSS, SSS, and PBCH in the center 1.08 MHz of the system bandwidth used by the eNB. The eNB may send the PCFICH and PHICH across the entire system bandwidth in each symbol period in which these channels are sent. The eNB may send the PDCCH to groups of UEs in certain portions of the system bandwidth. The eNB may send the PDSCH to specific UEs in specific portions of the system bandwidth. The eNB may send the PSS, SSS, PBCH, PCFICH, and PHICH in a broadcast manner to all UEs, may send the PDCCH in a unicast manner to specific UEs, and may also send the PDSCH in a unicast manner to specific UEs.

A number of resource elements may be available in each symbol period. Each resource element (RE) may cover one subcarrier in one symbol period and may be used to send one modulation symbol, which may be a real or complex value. Resource elements not used for a reference signal in each symbol period may be arranged into resource element groups (REGs). Each REG may include four resource elements in one symbol period. The PCFICH may occupy four REGs, which may be spaced approximately equally across frequency, in symbol period 0. The PHICH may occupy three REGs, which may be spread across frequency, in one or more configurable symbol periods. For example, the three REGs for the PHICH may all belong in symbol period 0 or may be spread in symbol periods 0, 1, and 2. The PDCCH may occupy 9, 18, 36, or 72 REGs, for example, which may be selected from the available REGs, in the first M symbol periods, for example. Only certain combinations of REGs may be allowed for the PDCCH.

A UE may know the specific REGs used for the PHICH and the PCFICH. The UE may search different combinations of REGs for the PDCCH. The number of combinations to search is typically less than the number of allowed combinations for the PDCCH. An eNB may send the PDCCH to the UE in any of the combinations that the UE will search.

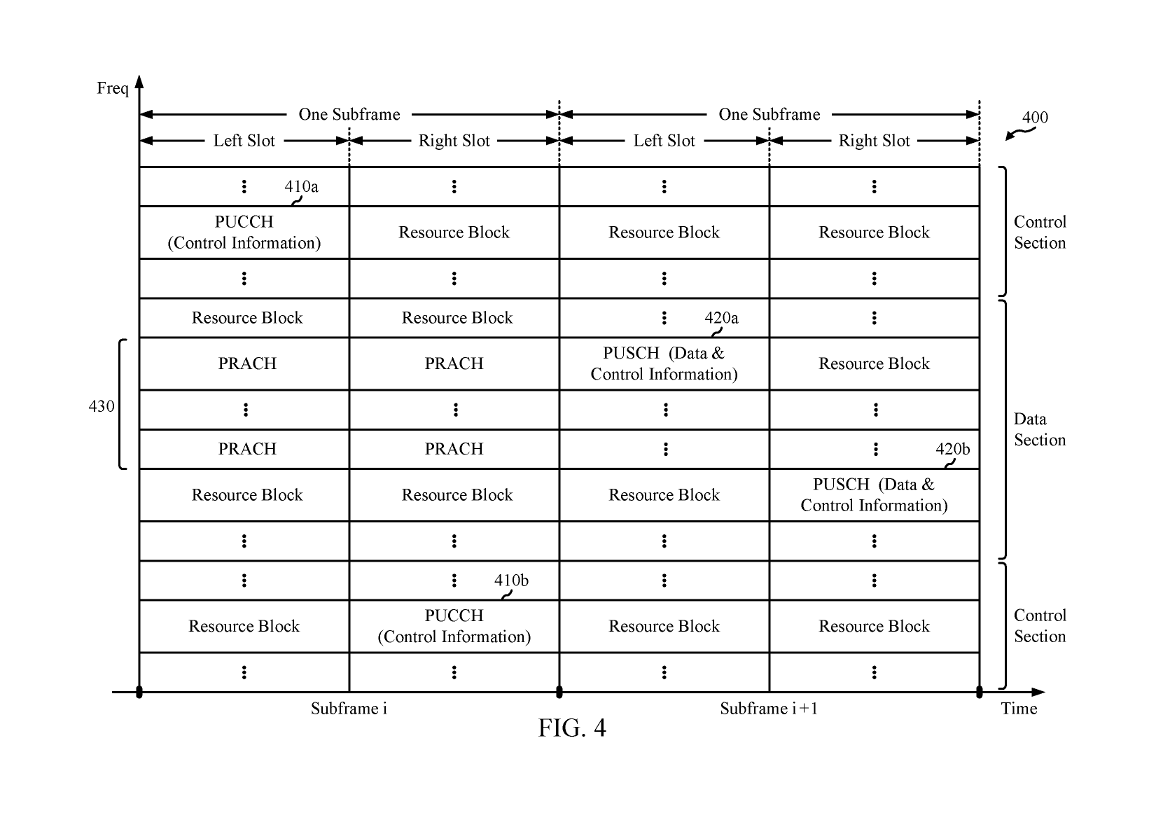

FIG. 4 is a diagram 400 illustrating an example of an UL frame structure in LTE. The available resource blocks for the UL may be partitioned into a data section and a control section. The control section may be formed at the two edges of the system bandwidth and may have a configurable size. The resource blocks in the control section may be assigned to UEs for transmission of control information. The data section may include all resource blocks not included in the control section. The UL frame structure results in the data section including contiguous subcarriers, which may allow a single UE to be assigned all of the contiguous subcarriers in the data section.

A UE may be assigned resource blocks 410a, 410b in the control section to transmit control information to an eNB. The UE may also be assigned resource blocks 420a, 420b in the data section to transmit data to the eNB. The UE may transmit control information in a physical UL control channel (PUCCH) on the assigned resource blocks in the control section. The UE may transmit only data or both data and control information in a physical UL shared channel (PUSCH) on the assigned resource blocks in the data section. A UL transmission may span both slots of a subframe and may hop across frequency.

A set of resource blocks may be used to perform initial system access and achieve UL synchronization in a physical random access channel (PRACH) 430. The PRACH 430 carries a random sequence and cannot carry any UL data/signaling. Each random access preamble occupies a bandwidth corresponding to six consecutive resource blocks. The starting frequency is specified by the network. That is, the transmission of the random access preamble is restricted to certain time and frequency resources. There is no frequency hopping for the PRACH. The PRACH attempt is carried in a single subframe (1 ms) or in a sequence of few contiguous subframes and a UE can make only a single PRACH attempt per frame (10 ms).

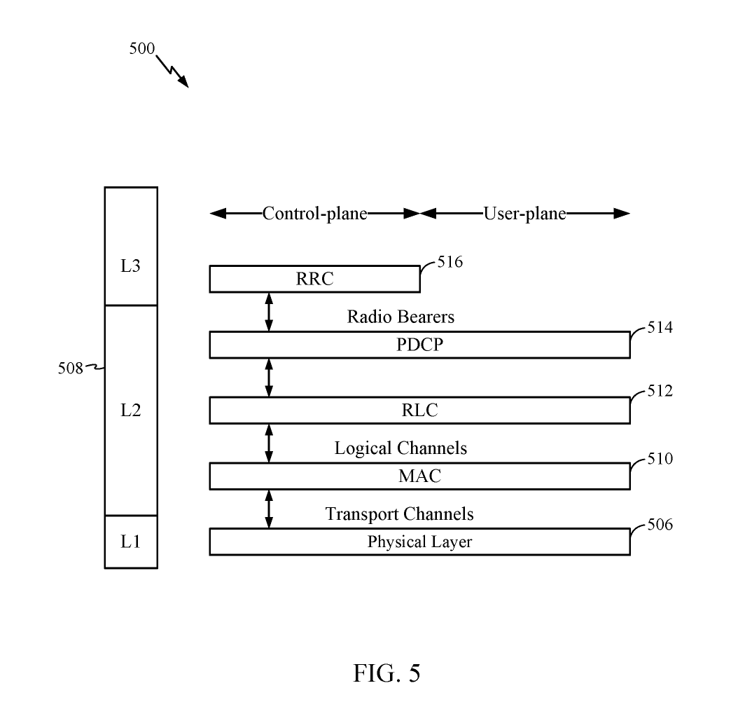

FIG. 5 is a diagram 500 illustrating an example of a radio protocol architecture for the user and control planes in LTE. The radio protocol architecture for the UE and the eNB is shown with three layers: Layer 1, Layer 2, and Layer 3. Layer 1 (L1 layer) is the lowest layer and implements various physical layer signal processing functions. The L1 layer will be referred to herein as the physical layer 506. Layer 2 (L2 layer) 508 is above the physical layer 506 and is responsible for the link between the UE and eNB over the physical layer 506.

In the user plane, the L2 layer 508 includes, for example, a media access control (MAC) sublayer 510, a radio link control (RLC) sublayer 512, and a packet data convergence protocol (PDCP) 514 sublayer, which are terminated at the eNB on the network side. Although not shown, the UE may have several upper layers above the L2 layer 508 including a network layer (e.g., IP layer) that is terminated at the PDN gateway 118 on the network side, and an application layer that is terminated at the other end of the connection (e.g., far end UE, server, etc.).

The PDCP sublayer 514 provides multiplexing between different radio bearers and logical channels. The PDCP sublayer 514 also provides header compression for upper layer data packets to reduce radio transmission overhead, security by ciphering the data packets, and handover support for UEs between eNBs. The RLC sublayer 512 provides segmentation and reassembly of upper layer data packets, retransmission of lost data packets, and reordering of data packets to compensate for out-of-order reception due to hybrid automatic repeat request (HARQ). The MAC sublayer 510 provides multiplexing between logical and transport channels. The MAC sublayer 510 is also responsible for allocating the various radio resources (e.g., resource blocks) in one cell among the UEs. The MAC sublayer 510 is also responsible for HARQ operations.

In the control plane, the radio protocol architecture for the UE and eNB is substantially the same for the physical layer 506 and the L2 layer 508 with the exception that there is no header compression function for the control plane. The control plane also includes a radio resource control (RRC) sublayer 516 in Layer 3 (L3 layer). The RRC sublayer 516 is responsible for obtaining radio resources (i.e., radio bearers) and for configuring the lower layers using RRC signaling between the eNB and the UE.

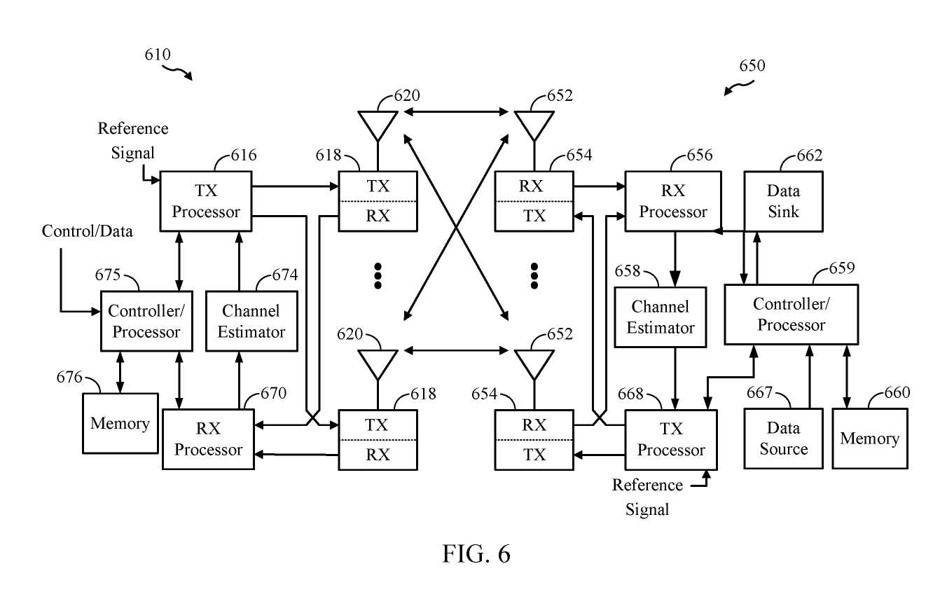

FIG. 6 is a block diagram of an eNB 610 in communication with a UE 650 in an access network in accordance with aspects of the present disclosure. The UE 102 of FIG. 1 may include one or more components as illustrated in FIG. 6. Similarly, the eNBs 106, 108 of FIG. 1 may include one or more components of eNB 610 as illustrated in FIG. 6.

In the DL, upper layer packets from the core network are provided to a controller/processor 675. The controller/processor 675 implements the functionality of the L2 layer. In the DL, the controller/processor 675 provides header compression, ciphering, packet segmentation and reordering, multiplexing between logical and transport channels, and radio resource allocations to the UE 650 based on various priority metrics. The controller/processor 675 is also responsible for HARQ operations, retransmission of lost packets, and signaling to the UE 650.

The TX processor 616 implements various signal processing functions for the L1 layer (i.e., physical layer). The signal processing functions includes coding and interleaving to facilitate forward error correction (FEC) at the UE 650 and mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols are then split into parallel streams. Each stream is then mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 674 may be used to determine the coding and modulation scheme, as well as for spatial processing. The channel estimate may be derived from a reference signal and/or channel condition feedback transmitted by the UE 650. Each spatial stream is then provided to a different antenna 620 via a separate transmitter 618TX. Each transmitter 618TX modulates an RF carrier with a respective spatial stream for transmission.

At the UE 650, each receiver 654RX receives a signal through its respective antenna 652. Each receiver 654RX recovers information modulated onto an RF carrier and provides the information to the receiver (RX) processor 656. The RX processor 656 implements various signal processing functions of the L1 layer. The RX processor 656 performs spatial processing on the information to recover any spatial streams destined for the UE 650. If multiple spatial streams are destined for the UE 650, they may be combined by the RX processor 656 into a single OFDM symbol stream. The RX processor 656 then converts the OFDM symbol stream from the time-domain to the frequency domain using a Fast Fourier Transform (FFT). The frequency domain signal comprises a separate OFDM symbol stream for each subcarrier of the OFDM signal. The symbols on each subcarrier, and the reference signal, is recovered and demodulated by determining the most likely signal constellation points transmitted by the eNB 610. These soft decisions may be based on channel estimates computed by the channel estimator 658. The soft decisions are then decoded and deinterleaved to recover the data and control signals that were originally transmitted by the eNB 610 on the physical channel. The data and control signals are then provided to the controller/processor 659.

The controller/processor 659 implements the L2 layer. The controller/processor 659 can be associated with a memory 660 that stores program codes and data. The memory 660 may be referred to as a computer-readable medium. In the UL, the controller/processor 659 provides demultiplexing between transport and logical channels, packet reassembly, deciphering, header decompression, control signal processing to recover upper layer packets from the core network. The upper layer packets are then provided to a data sink 662, which represents all the protocol layers above the L2 layer. Various control signals may also be provided to the data sink 662 for L3 processing. The controller/processor 659 is also responsible for error detection using an acknowledgement (ACK) and/or negative acknowledgement (NACK) protocol to support HARQ operations.

In the UL, a data source 667 is used to provide upper layer packets to the controller/processor 659. The data source 667 represents all protocol layers above the L2 layer. Similar to the functionality described in connection with the DL transmission by the eNB 610, the controller/processor 659 implements the L2 layer for the user plane and the control plane by providing header compression, ciphering, packet segmentation and reordering, and multiplexing between logical and transport channels based on radio resource allocations by the eNB 610. The controller/processor 659 is also responsible for HARQ operations, retransmission of lost packets, and signaling to the eNB 610.

Channel estimates derived by a channel estimator 658 from a reference signal or feedback transmitted by the eNB 610 may be used by the TX processor 668 to select the appropriate coding and modulation schemes, and to facilitate spatial processing. The spatial streams generated by the TX processor 668 are provided to different antenna 652 via separate transmitters 654TX. Each transmitter 654TX modulates an RF carrier with a respective spatial stream for transmission.

The UL transmission is processed at the eNB 610 in a manner similar to that described in connection with the receiver function at the UE 650. Each receiver 618RX receives a signal through its respective antenna 620. Each receiver 618RX recovers information modulated onto an RF carrier and provides the information to a RX processor 670. The RX processor 670 may implement the L1 layer.

The controller/processor 675 implements the L2 layer. The controller/processor 675 can be associated with a memory 676 that stores program codes and data. The memory 676 may be referred to as a computer-readable medium. In the UL, the controller/processor 675 provides demultiplexing between transport and logical channels, packet reassembly, deciphering, header decompression, control signal processing to recover upper layer packets from the UE 650. Upper layer packets from the controller/processor 675 may be provided to the core network. The controller/processor 675 is also responsible for error detection using an ACK and/or NACK protocol to support HARQ operations.

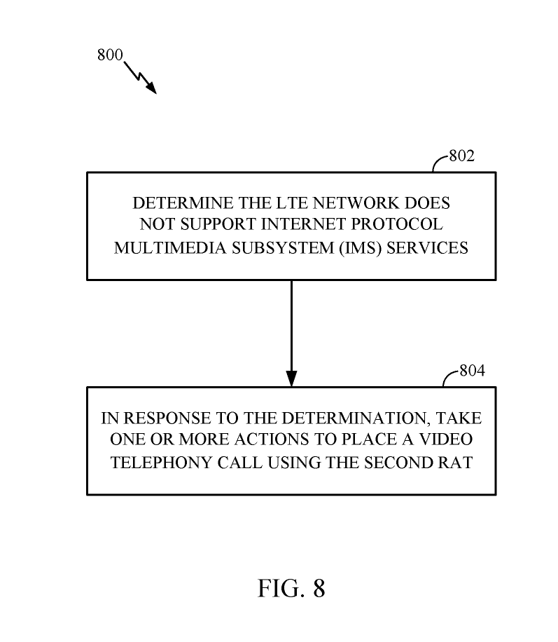

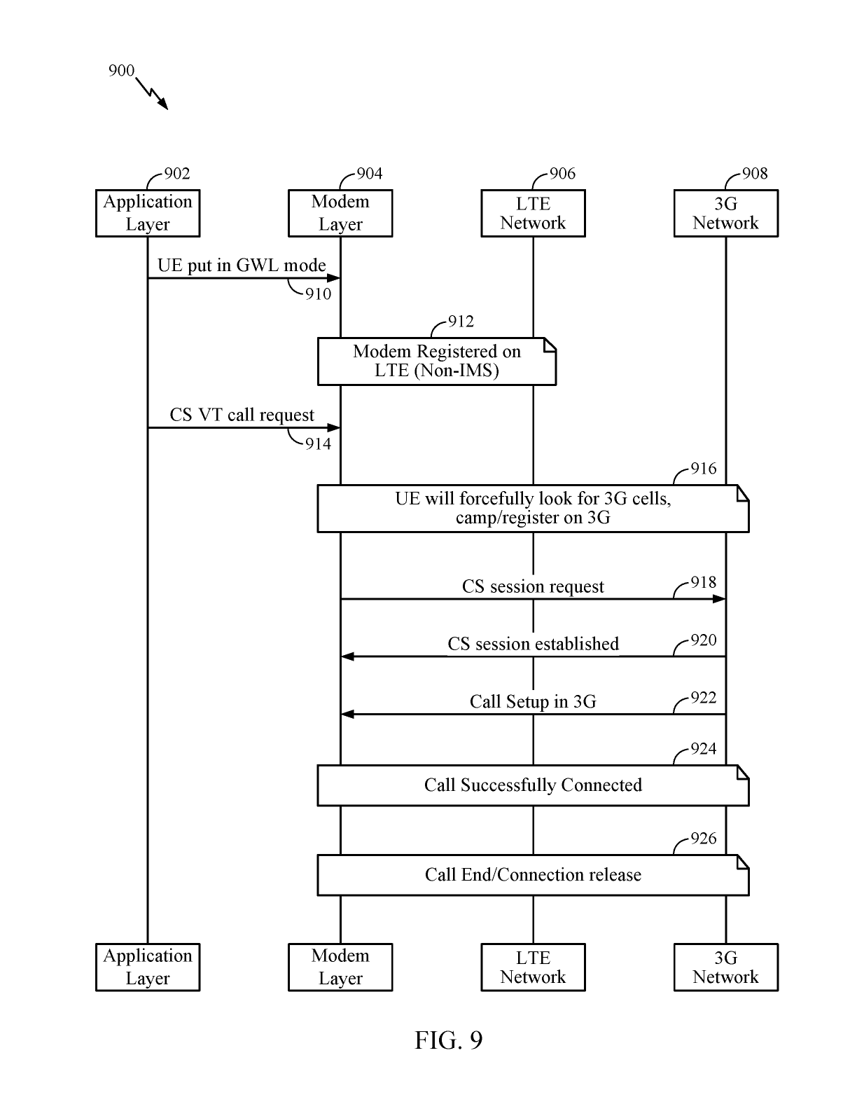

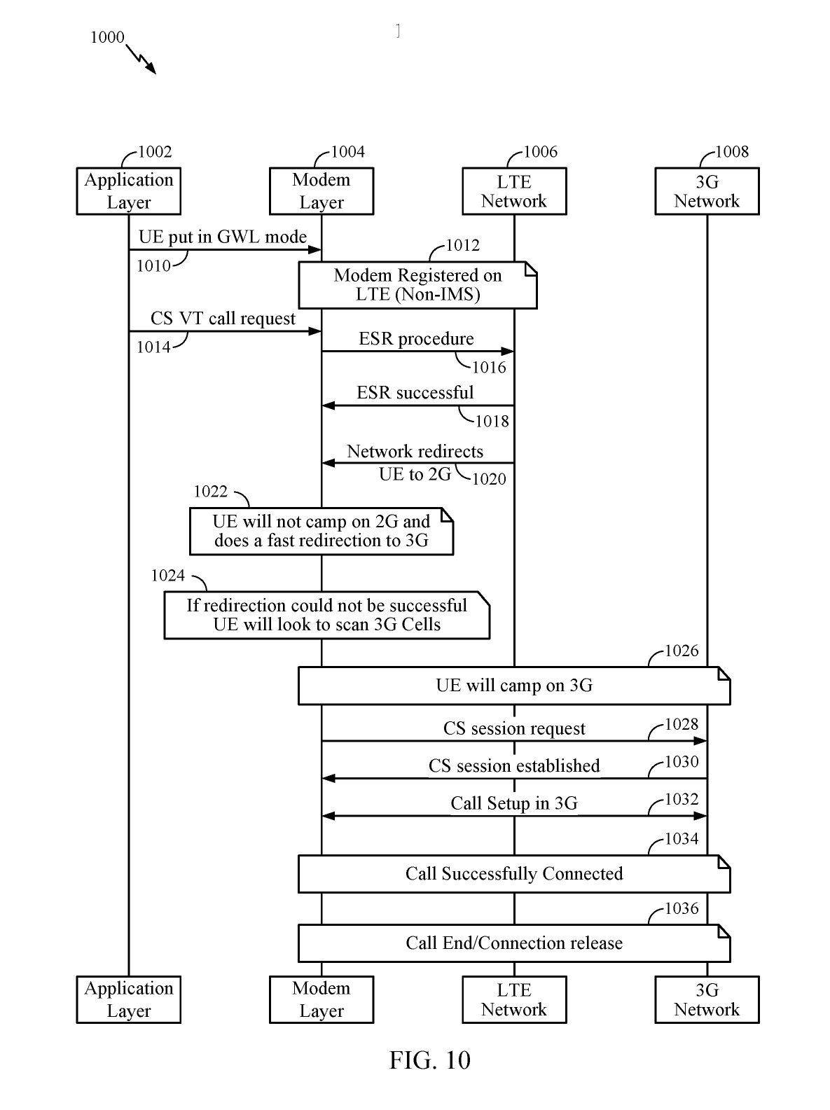

The controllers/processors 659 may direct the operation at the UE 650. The controller/processor 659 and/or other processors and modules at the UE 650 may perform or direct operations performed by the UE as described herein and as illustrated in FIGS. 8-10. In aspects, one or more of any of the components shown in FIG. 6 may be employed to perform example operations 800, and the UE operations 900, 1000 as shown and described with reference to FIGS. 9 and 10 and/or other processes for the techniques described herein and illustrated in the appended drawings.

For example, the UE 650 may be camped on an LTE network (e.g., 100 from FIG. 1). The UE 650 may also be in the coverage area of a first RAT (e.g., GSM 126) supported by a first standard and a second RAT (e.g., CDMA 124) supported by a second standard. The controller/processor 659 and/or any other processor module at the UE 650 may determine that the LTE network does not support IMS services. In response to the determination, one or more modules at the UE, including the controller/processor module 659, may take one or more actions to place a video telephony call on the second RAT (e.g., via a second RAT network).

### Example Methods and Apparatus for Placing a Video Telephony Call for Non-IMS Subscriptions

A UE may be in the coverage area of multiple RATs, which may support different communication services. For example, certain 4G deployments may not support IMS services. Therefore, a UE camped on a 4G network (e.g., LTE) that does not support IMS services may need to be redirected to a network which supports IMS services to place a circuit switched video telephony (CS VT) call.

Upon receiving a call request (e.g., associated with a CS VT call), the 4G network on which the UE is camped may not know whether the call is a CS voice call or a CS VT call. For example, the 4G network on which the UE is camped may not know whether a received request is associated with a CS voice call or a CS VT call. Therefore, a problem may arise if the 4G network redirects the VT call to a network which does not support a VT call as opposed to a network that does support a VT call. For example, the 4G network may redirect the VT call to a network that may not support IMS services, and therefore may not support a VT call. As an example, the 4G network may redirect the VT call to 2G network, as opposed to a network which does support a VT call such as, for example, a 3G network.

Aspects of the present disclosure provide methods for the UE to register on a network that supports a VT call before placing the VT call. Advantageously, aspects described herein allow a UE to place a CS VT call in a network that supports IMS services, thereby avoiding a CS VT call failure due to being redirected to a network that does not support IMS services.

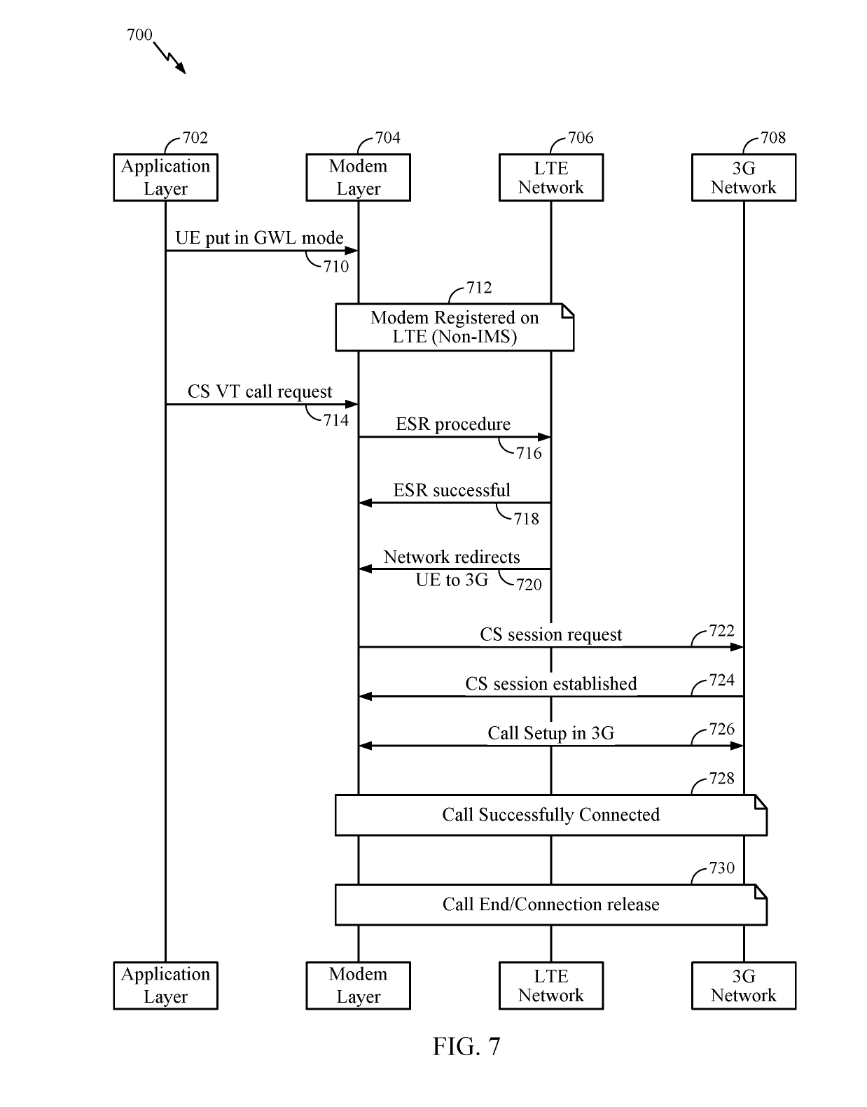

FIG. 7 illustrates an example call-flow diagram 700 illustrating an LTE network 706 redirecting a UE, which includes an Application Layer 702 and a Modem Layer 704, to a 3G network 708, which supports IMS services when a CS VT call request is received. The LTE network 706 may include one or more components from the LTE network 100, the UE may be UE 102, and the 3G network 708 may be the 3G subscription 124 illustrated in FIG. 1. The UE 102 may include one or more components of UE 650 illustrated in FIG. 6.

At 710, the UE 102, 650 is placed in a system selection preference (SSP) of GSM, WCDMA, or LTE (GWL). At 712, the UE registers with the LTE network which does not support IMS services. At 714, the Modem Layer receives a VT call (e.g., CS VT call) request.

In response to the VT call request, at 716, the UE begins an Extended Service Request (ESR) procedure (e.g., by issuing an ESR), with the LTE network. The ESR procedure is successfully completed at 718. The ESR procedure may release the UE context in the LTE network. The ESR may cause the LTE network to suspend data transmission to the UE and/or UE context while the UE is on a call (e.g., CS VT call). At 720, the LTE network redirects the UE to a 3G network.

At 722, the Modem Layer transmits a CS session request to the 3G network. The CS session is established at 724. At 726, signaling between the UE and the 3G network may occur for call setup in 3G. At 728, the VT call is successfully connected in the 3G network. At 730, the VT call is terminated, and the UE discontinues the communication session with the 3G network.

Upon receiving a request (e.g., the ESR at 716) associated with the circuit switched VT call request, the 4G network may not know whether the call is a CS voice call or a CS VT call. Accordingly, a problem may arise if the UE is redirected to a network that does not support IMS services. For example, a VT call may fail (e.g., not be successfully placed) if the UE in FIG. 7 is directed to a network, such as a 2G network that does not support IMS services.

FIG. 8 illustrates example operations 800 performed by UE for placing a VT call, according to aspects of the present disclosure. UE 102 which may have one or more components of UE 650 may perform the described operations. For example, the controller/processor 659 and/or any other component of a UE 102, 650 may perform aspects described herein.

The UE 102, 650 may be camped on an LTE network that does not support IMS services and may be in the coverage area of at least one network which supports IMS services and at least one other network which does not support IMS services. For example, the UE 102, 650 may be in the coverage area of a first RAT supported by a first standard, which does not support IMS services and a second RAT supported by a second standard, which does support IMS services. For illustrative purposes, the first RAT may be a 2G subscription and the second RAT may be a 3G subscription.

At 802, the UE 102, 650 may determine the LTE network does not support IMS services. In response to the determination, at 804, the UE 102, 650 may take one or more actions to place a VT call using the second RAT.

FIGS. 9 and 10 illustrate example operations 900 and 1000, respectively, which may be performed to place the VT call using the second RAT, according to aspects of the present disclosure. In both FIGS. 9 and 10, the UE 102, 650 includes an Application Layer and a Modem Layer. Additionally, the UE is camped on a non-IMS LTE network when it receives a VT call request.

FIG. 9 illustrates operations 900, in which the UE 102, 650 searches for a network that supports IMS services before VT call setup, according to aspects of the present disclosure.

At 910, the UE 102, 650 is placed in GWL mode. At 912, the Modem Layer 904 registers the UE on the LTE network 906. At 914, the Modem Layer receives a VT call (e.g., CS VT call) request.

According to aspects, instead of performing an ESR procedure with the LTE network (e.g., as shown at 716 in FIG. 7), the UE may search for a network that supports IMS services upon receiving a VT call request. Accordingly, at 916, the UE may search for and register (e.g., camp) on a 3G network 908. If the UE does not find a 3G network or a network that supports IMS services, a call failure may be indicated to a user and the UE may move back to the LTE network 906.

If the UE finds a 3G network, at 918, the UE may request a CS session with the discovered 3G network. The CS session may be established at 920. At 922, signaling between the UE and the 3G network may setup the VT call on the 3G network. The VT call may successfully be connected at 924. Upon termination of the VT call, at 926, the connection with the 3G network may be discontinued.

FIG. 10 illustrates example operations 1000 in which the UE 102, 650 performs an ESR procedure with the LTE network (e.g., as shown in FIG. 7) after receiving a VT call request. However, as illustrated in FIG. 10, the UE 102, 650 may avoid being redirected to a RAT that does not support IMS services.

At 1010, the UE 102, 650 is placed in a GWL mode. At 1012, the Modem Layer 1004 registers the UE on the LTE network 1006. At 1014, the Modem Layer receives a CS call (e.g., CS VT call) request.

At 1016, the UE begins an ESR procedure with the LTE network 1006. The ESR procedure is successfully completed at 1018. In effect, the ESR procedure may request suspension of context for the UE in the LTE network. At 1020, the LTE network 1006 redirects the UE to a 2G network (e.g., a GSM network).

As the 2G network will not support placing the CS VT call, instead of moving to the 2G network, the UE performs at least one of a fast redirection to a RAT which supports IMS services and/or a scan for networks that support IMS services. Accordingly, at 1022, the UE may not camp on the 2G network and the UE may perform a fast redirection to 3G (e.g., via a 3G network 1008). At 1024, if redirection to a 3G network is not successful, the UE may scan for other 3G networks.

At 1026, the UE may camp on the discovered 3G network 1008. If the UE does not find a 3G network or a network that supports IMS, a call failure may be indicated to a user and the UE may move back to the LTE network 1006.

If redirection from steps 1022 and/or 1024 are successful, at 1028, the Modem Layer may transmit a CS session request to the 3G network 1008. At 1030, the CS session may be established. At 1032, signaling between the UE 102, 650 and the 3G network 1008 may setup the VT call on the 3G network 1008. The VT call may be successfully connected at 1034. Upon termination of the VT call, at 1036, the connection with the 3G network may be discontinued.

Aspects described herein allow a UE 102, 650 to place a VT call on a network that supports IMS (e.g., a 3G network). Absent the techniques described herein, the VT call may otherwise have failed, for example, if the LTE network had redirected the UE 102, 650 to a subscription which does not support IMS services (e.g., a 2G network). As described with reference to FIG. 9, the UE may search for a 3G network upon receiving a VT call request. As described with reference to FIG. 10, the UE may avoid transferring to a 2G network as a result of an ESR procedure. Accordingly, a UE camped on a non-IMS LTE network may take one or more actions after receiving a VT call request, to successfully place a VT call using a RAT which supports IMS services, thereby improving VT call setup success rate and improving an end user's experience.

It is understood that the specific order or hierarchy of steps in the processes disclosed is an illustration of exemplary approaches. Based upon design preferences, it is understood that the specific order or hierarchy of steps in the processes may be rearranged. Further, some steps may be combined or omitted. The accompanying method claims present elements of the various steps in a sample order, and are not meant to be limited to the specific order or hierarchy presented.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” Unless specifically stated otherwise, the term “some” refers to one or more. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed as a means plus function unless the element is expressly recited using the phrase “means for.”

The described and recited means, including, for example, the means for determining, means for taking one or more actions, means for searching, means for establishing, means for placing a video telephony call, means for discontinuing a communication session upon termination of the video telephony call, means for performing an Extended Service Request (ESR) procedure, means for being redirected to a first RAT as a result of the ESR procedure, means for taking one or more actions to move from the LTE network to the second RAT, means for performing a redirection, means for scanning for available networks associated with the second RAT, means for avoiding transfer to the first RAT as a result of the ESR procedure may be performed by a UE 120 which may include components of the UE 650 illustrated in FIG. 6. Further, as described above the UE may include an Application Layer and Modem Layer as shown in FIGS. 9-10. As an example, one or more of the Tx/Rx 654, antenna 652, controller/processor 659, and/or memory 660 may be configured to perform the aspects described herein and illustrated in the accompanying figures.

1. A method for wireless communication by a user equipment (UE) camped on a Long Term Evolution (LTE) network, in a coverage area of a first radio access technology (RAT) supported by a first standard, and in a coverage area of a second RAT supported by a second standard, comprising:
determining the LTE network does not support Internet Protocol Multimedia Subsystem (IMS) services; and
in response to the determination, taking one or more actions to place a video telephony call using the second RAT.

2. The method of claim 1, wherein taking the one or more actions comprises:
searching for the second RAT upon receiving a video telephony call request;
establishing a communication session using the second RAT; and
placing the video telephony call using the second RAT.

3. The method of claim 2, further comprising:
discontinuing the communication session with the second RAT upon termination of the video telephony call.

4. The method of claim 1, wherein taking the one or more actions comprises:
performing an Extended Service Request (ESR) procedure with the LTE network;
being redirected to the first RAT as a result of the ESR procedure;
taking one or more actions to move from the LTE network to the second RAT; and
placing the video telephony call using the second RAT.

5. The method of claim 4, wherein taking the one or more actions to move from the LTE network to the second RAT comprises at least one of:
performing a redirection to the second RAT or scanning for available networks associated with the second RAT.

6. The method of claim 4, further comprising:
discontinuing a communication session with the second RAT upon termination of the video telephony call.

7. The method of claim 1, wherein taking the one or more actions comprises:
performing an Extended Service Request (ESR) procedure with the LTE network upon receiving a video telephony call request; and
avoiding transfer to the first RAT as a result of the ESR procedure.

8. The method of claim 1, wherein the first RAT does not support video telephony services.

9. The method of claim 1, wherein at least one of the first RAT comprises a 2G RAT or the second RAT comprises a 3G RAT.

10. An apparatus for wireless communication by a user equipment (UE) camped on a Long Term Evolution (LTE) network, in a coverage area of a first radio access technology (RAT) supported by a first standard, and in a coverage area of a second RAT supported by a second standard, comprising:
means for determining the LTE network does not support Internet Protocol Multimedia Subsystem (IMS) services; and
in response to the means for determining, means for taking one or more actions to place a video telephony call using the second RAT.

11. The apparatus of claim 10, wherein the means for taking the one or more actions comprises:
means for searching for the second RAT upon receiving a video telephony call request;
means for establishing a communication session using the second RAT; and
means for placing the video telephony call using the second RAT.

12. The apparatus of claim 11, further comprising:
means for discontinuing the communication session with the second RAT upon termination of the video telephony call.

13. The apparatus of claim 10, wherein the means for taking the one or more actions comprises:
means for performing an Extended Service Request (ESR) procedure with the LTE network;
means for being redirected to the first RAT as a result of the ESR procedure;
means for taking one or more actions to move from the LTE network to the second RAT; and
means for placing the video telephony call using the second RAT.

14. The apparatus of claim 13, wherein the means for taking the one or more actions to move from the LTE network to the second RAT comprises at least one of:
means for performing a redirection to the second RAT or means for scanning for available networks associated with the second RAT.

15. The apparatus of claim 13, further comprising:
means for discontinuing a communication session with the second RAT upon termination of the video telephony call.

16. The apparatus of claim 10, wherein the means for taking the one or more actions comprises:
means for performing an Extended Service Request (ESR) procedure with the LTE network upon receiving a video telephony call request; and
means for avoiding transfer to the first RAT as a result of the ESR procedure.

17. The apparatus of claim 10, wherein the first RAT does not support video telephony services.

18. The apparatus of claim 10, wherein at least one of the first RAT comprises a 2G RAT or the second RAT comprises a 3G RAT.

19. An apparatus for wireless communication camped on a Long Term Evolution (LTE) network, in a coverage area of a first radio access technology (RAT) supported by a first standard, and in a coverage area of a second RAT supported by a second standard, comprising:
at least one processor configured to:
determine the LTE network does not support Internet Protocol Multimedia Subsystem (IMS) services; and
in response to the determining, means for taking one or more actions to place a video telephony call using the second RAT; memory
a memory coupled to the at least one processor.

20. The apparatus of claim 19, wherein the at least one processor is configured to take the one or more actions by:
searching for the second RAT upon receiving a video telephony call request;
establishing a communication session using the second RAT; and
placing the video telephony call using the second RAT.
